(19) United States
(12) Patent Application Publication
(10) Pub. No.: US 2006/0044225 A1
(43) Pub. Date: Mar. 2, 2006

(54) Plasma display and driving method thereof

(76) Inventor: Tae-Kyoung Kang, Suwon-si (KR)

Correspondence Address: CHRISTIE, PARKER & HALE, LLP, PO BOX 7068, PASADENA, CA, 91109-7068, US

(21) Appl. No.: 11/202,759

(22) Filed: Aug. 11, 2005

(30) Foreign Application Priority Data
Aug. 30, 2004 (KR) 10-2004-0068534

(51) Int. Cl. G09G 3/28

(52) U.S. Cl. 345/63

(57) ABSTRACT

A plasma display for applying a voltage Vₛ and a voltage −Vₛ to the scan electrodes and for applying a ground voltage to the sustain electrodes during a sustain period. The voltage −Vₛ is applied to the scan electrodes after the voltage of the scan electrodes is reduced from the voltage Vₛ to a voltage Vₛ₁ which is higher than the ground voltage and is reduced from the voltage Vₛ₁ to the voltage −Vₛ. The voltage Vₛ is applied to the scan electrodes after the voltage of the scan electrodes is increased from the voltage −Vₛ to a voltage Vₛ₂ which is lower than the ground voltage and is increased from the voltage Vₛ₂ to the voltage Vₛ.

### CROSS-REFERENCE TO RELATED APPLICATION

This application claims priority to and the benefit of Korean Patent Application No. 10-2004-0068534 filed in the Korean Intellectual Property Office on Aug. 30, 2004, the entire content of which is incorporated herein by reference.

### BACKGROUND OF THE INVENTION

1. Field of the Invention

The present invention relates to a plasma display and a driving method thereof.

2. Description of the Related Art

A plasma display is a display device that uses plasma generated by gas discharge in discharge cells to display characters or images. Depending on its size, a plasma display panel (PDP) of the plasma display includes more than several hundreds of thousands to millions of pixels arranged in a matrix pattern.

One frame of the plasma display is divided into a plurality of subfields, and each subfield includes a reset period, an address period, and a sustain period. The reset period is for initializing the status of each discharge cell so as to facilitate an addressing operation on the discharge cell. The address period is for selecting turn-on/turn-off cells among the discharge cells, and the sustain period is for causing the turn-on cells to continue discharge for displaying an image.

In order to perform the above operations and to display an image, sustain pulses are alternately applied to scan electrodes and sustain electrodes during the sustain period, and reset waveforms and address waveforms are applied to the scan electrodes during the reset period and the address period. Therefore, a scan driving board for driving the scan electrodes and a sustain driving board for driving the sustain electrodes are separately needed. Mounting the two separate driving boards on a chassis base may generate problems and increase the overall cost of the device.

Therefore, for combining the two driving boards into a single combined board, schemes of coupling the single combined board to the scan electrodes and extending the sustain electrodes to reach the combined board have been proposed. However, when the two driving boards are combined as such, the impedance component created at the extended sustain electrodes is increased. As a result, a distortion is generated in the sustain pulse.

### SUMMARY OF THE INVENTION

The present invention provides a plasma display for eliminating a driving board for driving a sustain electrode or reducing its size and complexity. The present invention also provides a plasma display for preventing a self-erasing discharge during the sustain period.

An exemplary embodiment of the present invention discloses a driving method of a plasma display. The plasma display displays an image during a frame being divided into a plurality of subfields, and includes first electrodes, second electrodes, and third electrodes extending substantially perpendicular to the first electrodes and the second electrodes. A first voltage is applied to the first electrodes during the sustain period of each subfield. During the sustain period, the driving method includes applying a second voltage which is higher than the first voltage to the second electrodes, reducing a voltage of the second electrodes from the second voltage to a third voltage, reducing the voltage of the second electrodes from the third voltage to a fourth voltage which is lower than the first voltage, applying the fourth voltage to the second electrodes, increasing the voltage of the second electrodes from the fourth voltage to a fifth voltage which is lower than the second voltage, and increasing the voltage of the second electrodes from the fifth voltage to the second voltage. At least one of the third voltage and the fifth voltage is different from a sixth voltage which is a mean of the second voltage and the fourth voltage.

The third voltage may be higher than the sixth voltage, and the fifth voltage may be lower than the sixth voltage.

In addition, a seventh voltage may be applied to the first electrodes in a portion of a reset period and an address period of the subfield. The seventh voltage may be equal to the first voltage, and the first voltage may be a ground voltage.

Another exemplary embodiment of the present invention discloses a plasma display. The plasma display includes a PDP, a controller, and a driver. The PDP includes a plurality of first electrodes, a plurality of second electrodes and a plurality of third electrodes, the third electrodes extending substantially perpendicular to the first electrodes and the second electrodes. The controller divides a frame into a plurality of subfields. The driver applies a first voltage to the first electrodes and applies a second voltage which is higher than the first voltage and a third voltage which is lower than the first voltage in turn to the second electrodes, during a sustain period of each subfield. In at least one of a first period during which the voltage of the second electrodes is reduced from the second voltage to the third voltage and a second period during which the voltage of the second electrodes is increased from the third voltage to the second voltage, the driver applies a fourth voltage different from the first voltage to the second electrodes during a third period shorter than the first and second periods.

### BRIEF DESCRIPTION OF THE DRAWINGS

FIG. 1 shows an exploded perspective view of a plasma display according to an exemplary embodiment of the present invention.

FIG. 2 shows a schematic view of a PDP according to an exemplary embodiment of the present invention.

FIG. 3 shows a plan view of a chassis base of a plasma display according to an exemplary embodiment of the present invention.

FIG. 4 shows a driving waveform of the plasma display according to a first exemplary embodiment of the present invention.

FIG. 5 shows a driving waveform of the plasma display according to a second exemplary embodiment of the present invention.

### DETAILED DESCRIPTION

In the following detailed description, only exemplary embodiments of the invention have been shown and described. Accordingly, the drawings and description are to be regarded as illustrative in nature, and not restrictive.

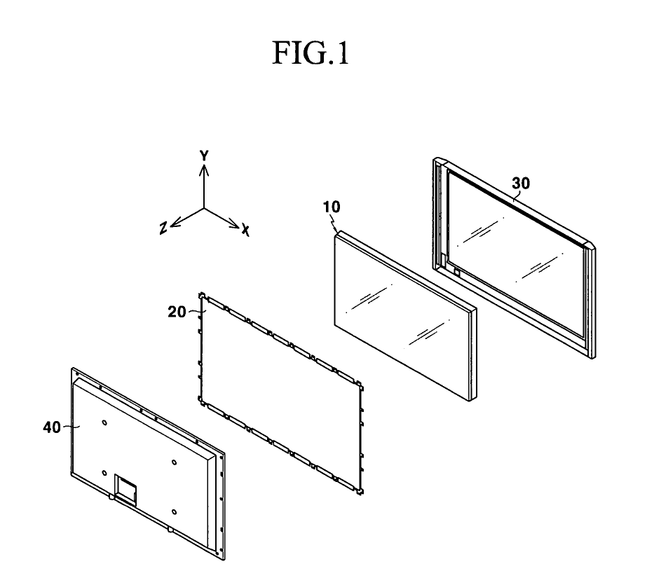

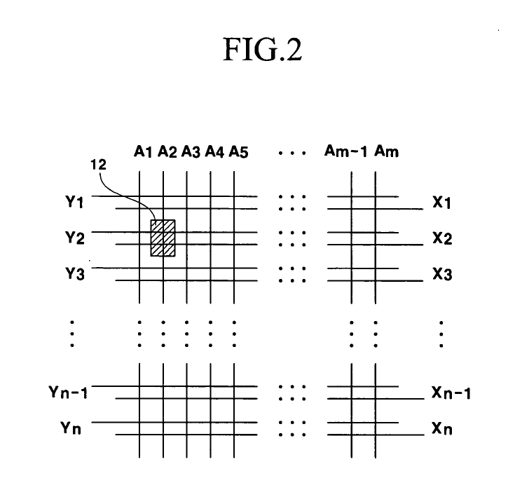

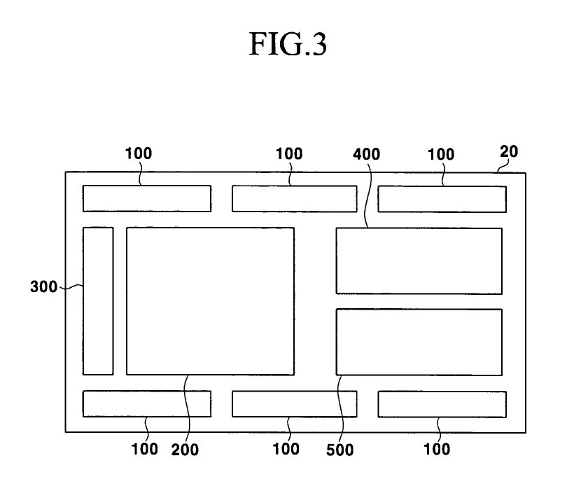

A schematic configuration of a plasma display according to an embodiment of the present invention is shown in FIG. 1, FIG. 2, and FIG. 3.

Referring to FIGS. 1, 2, and 3, the plasma display includes a PDP 10, a chassis base 20, a front case 30, and a rear case 40. The chassis base 20 is coupled to the PDP 10 opposite an image display side of the PDP 10. The front case 30 is coupled to the PDP 10 on the image display side of the PDP 10. The rear case 40 is coupled to the chassis base 20. The assembly of these parts forms a plasma display.

As shown in FIG. 2, the PDP 10 of FIG. 1 includes a plurality of address (A) electrodes A₁ to Aₘ extending in a column direction, and a plurality of scan (Y) electrodes Y₁ to Yₙ and a plurality of sustain (X) electrodes X₁ to Xₙ each extending in a row direction. The respective X electrodes X₁ to Xₙ correspond to the respective Y electrodes Y₁ to Yₙ, and the X and Y electrodes perform a display operation for displaying an image during a sustain period. The sub-pixel area delineating a discharge space where the A electrodes cross the Y and X electrodes forms a discharge cell 12.

As shown in FIG. 3, driving boards 100, 200, 300, 400, 500 for driving the PDP 10 are formed on the chassis base 20. Address buffer boards 100 are formed on top and bottom of the chassis base 20. The configuration shown is considered a dual driving scheme, providing address voltages from both top and bottom sides of the chassis base 20, and may be altered depending on the driving scheme. For example, in a single driving scheme, the address buffer boards 100 may be located on either the top or the bottom of the chassis base 20. Further, the address buffer board 100 may be formed as a single board or a combination of a plurality of boards.

The address buffer board 100 receives an address driving control signal from a control board 400 and applies a voltage for selecting a turn-on discharge cell (or a turn-off discharge cell) to the appropriate A electrodes. The X electrodes are biased at a constant reference voltage.

A scan driving board 200 is located on a left area of the chassis base 20 and is coupled to the Y electrodes through a scan buffer board 300. During an address period, the scan buffer board 300 applies a voltage to the Y electrodes for sequentially selecting scan electrodes Y₁ to Yₙ. The scan driving board 200 receives a driving signal from the control board 400 and applies a driving voltage to the Y electrodes. While, in FIG. 3, the scan driving board 200 and the scan buffer board 300 are shown on the left side of the chassis base 20, they may be located on the right side of the chassis base 20. Also, the scan buffer board 300 and the scan driving board 200 may be combined together as one integral part.

Upon receiving an external image signal, the control board 400 generates a control signal for driving the A electrodes and a control signal for driving the Y and X electrodes. The control board 400 subsequently applies the control signals to the address buffer board 100, the scan driving board 200, and the scan buffer board 300. A power supply board 500 supplies the power for driving the plasma display. The control board 400 and the power supply board 500 are located on a central area of the chassis base 20.

The address buffer board 100, the scan driving board 200 and the scan buffer board 300 are operated as a driver of the PDP 10. The control board 400 is operated as a controller of the PDP 10. The power supply board 500 is operated as a power source of the PDP 10.

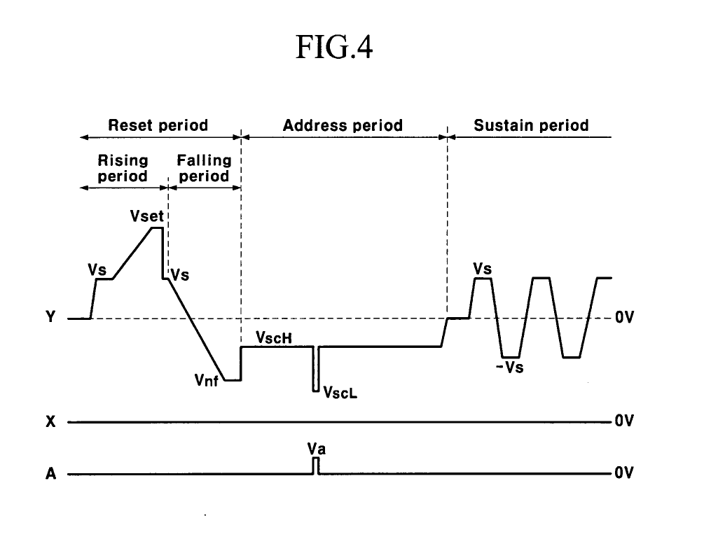

FIG. 4 shows a driving waveform of the plasma display according to a first exemplary embodiment of the present invention. For convenience of description, driving waveforms applied to a Y electrode, an X electrode, and an A electrode are exemplarily described in connection with only one discharge cell 12 (FIG. 2). In the driving waveform shown in FIG. 4, and referring to FIG. 3, the Y electrode receives a voltage from the scan driving board 200 and the scan buffer board 300, and the A electrode receives a voltage from the address buffer board 100. The X electrode is biased at a constant reference voltage, represented as a ground voltage (0V) in FIG. 4.

As explained above, the plasma display is driven during frames and frames are divided into subfields. As shown in FIG. 4, one subfield of the driving waveform is divided into three periods, the reset period, the address period, and the sustain period. The reset period has a rising period and a falling period.

Referring to FIG. 4, during the rising period of the reset period, the voltage of the Y electrode is gradually increased from a voltage Vₛ to a voltage Vₛₑₜ while the A electrode is maintained at a reference voltage 0V. The voltage of the Y electrode increases in a ramp between voltage Vₛ and voltage Vₛₑₜ. As the voltage of the Y electrode is increased, a weak discharge is generated between the Y and X electrodes and between Y and A electrodes, and negative (−) wall charges are formed on the Y electrode and positive (+) wall charges are formed on the X and A electrodes. In addition, when the voltage of the Y electrode changes gradually, as shown in FIG. 4, a weak discharge is caused in the discharge cell 12, and accordingly, wall charges are formed such that a sum of an externally applied voltage and a wall voltage may be maintained at a discharge firing voltage.

Wall charges being described in the present invention refer to charges formed on a wall of the discharge cell 12 close to each electrode (X, Y, or A) and accumulated on the electrode. The wall charge is described as being “formed” or “accumulated” on the electrode (X, Y, or A) although the wall charges do not actually touch the electrodes. Further, a wall voltage means a potential difference formed between the walls of the discharge cell 12 by the wall charges.

The voltage Vₛₑₜ is a voltage high enough to fire a discharge in discharge cells 12 of any condition because every discharge cell 12 has to be initialized during the reset period. Generally, the voltage Vₛ is equal to the voltage applied to the Y electrode during the sustain period, and is less than a voltage required for firing discharge between the Y electrode and X electrode.

During the falling period of the reset period, the voltage of the Y electrode is gradually reduced from the voltage Vₛ to a voltage V_{nf} while the voltage of the A electrode is maintained at the reference voltage. As a result, a weak discharge is generated between the Y and X electrodes and between the Y and A electrodes while the voltage of the Y electrode is reduced, and accordingly, the negative (−) wall charges formed on the Y electrode and the positive (+) wall charges formed on the X and A electrodes are eliminated. The voltage V_{nf} is set to be close to a discharge firing voltage between the Y and X electrodes. Then, the wall voltage between the Y and X electrodes reaches near 0V, and therefore, a discharge cell 12 that was not addressed with an address discharge during the address period may be prevented from misfiring during the sustain period. The wall voltage between the Y and A electrodes is determined by the magnitude of V_{nf} because the voltage of the A electrode is maintained at the reference voltage 0V.

Subsequently, during the address period for selecting the on discharge cells 12, a scan pulse V_{scL} and an address pulse Vₐ are applied to the Y electrode and the A electrode of the on the discharge cell 12, respectively. A non-selected Y electrode is biased at a voltage V_{scH} which is higher than V_{scL}, and the reference voltage is applied to the A electrode of the discharge cell being turned off. The scan buffer board 300 selects a Y electrode to be applied with the scan pulse of V_{scL}, among the scan electrodes Y₁ to Yₙ. For example, in the single driving method, the Y electrodes may be selected in an order of arrangement of the Y electrodes in the column direction. When a Y electrode is selected, the address buffer board 100 selects discharge cells 12 to be turned on among the discharge cells along the selected Y electrode. That is, the address buffer board 100 selects the A electrodes to which the address pulse of the voltage Vₐ is applied among the address electrodes A₁ to Aₘ.

The scan pulse, in the form of the voltage V_{scL}, is first applied to the Y electrode in the first row (Y₁). At the same time, the address pulse, in the form of the voltage Vₐ, is applied to the A electrode on the discharge cells 12 to be turned on along the first row. Then, after a discharge is generated between the Y electrode in the first row (Y₁) and the A electrode receiving the voltage Vₐ, a discharge is generated between the Y electrode and the X electrode. Accordingly, positive (+) wall charges are formed on the Y electrode and negative (−) wall charges are formed on the A electrode and X electrode. As a result, a wall voltage V_{wxy} is formed between the X and Y electrodes with the potential of the wall adjacent to the Y electrode being higher than the potential of the wall adjacent to the X electrode. Subsequently, while the scan voltage, in the form of the voltage V_{scL}, is applied to the Y electrode in a second row (Y₂), the address pulse, in the form of the voltage Vₐ, is applied to the A electrodes in discharge cells 12 to be turned on along the second row. Then, the address discharge is generated in the discharge cells 12 crossed by the A electrodes receiving the voltage Vₐ and the Y electrode in the second row (Y₂) and accordingly, wall charges are formed in those discharge cells 12 in the manner described above. Regarding Y electrodes in other rows, wall charges are formed in discharge cells 12 to be turned on in the same manner as described above, i.e., by applying the address pulse, the voltage Vₐ, to A electrodes on discharge cells 12 to be turned on while sequentially applying a scan pulse, voltage V_{scL}, to the Y electrodes from the first row (Y₁) to the last row (Yₙ).

During the address period described above, the voltage V_{scL} is usually set to be lower than or equal to the voltage V_{nf}, and the voltage Vₐ is usually set to be higher than the reference voltage. Generation of address discharge by applying the voltage Vₐ to the A electrode when the voltage V_{scL} equals the voltage V_{nf} is now described. When the voltage V_{nf} is applied in the reset period, a sum of the wall voltage between the A and Y electrodes and the external voltage V_{nf} between the A and the Y electrodes reaches the discharge firing voltage V_{fay} between the A and Y electrodes. For example, when 0V is applied to the A electrode and the voltage V_{scL}, that is equal to V_{nf} in this case, is applied to the Y electrode during the address period, the voltage V_{fay} is formed between the A and Y electrodes, and accordingly generation of a discharge may be expected. However, in this case, the expected discharge is not generated because a discharge delay is greater than the width of the scan pulse and the address pulse. If the voltage Vₐ is applied to the A electrode and the voltage V_{scL}=V_{nf} is applied to the Y electrode, a voltage greater than the firing voltage V_{fay} is formed between the A and Y electrodes, and accordingly, the discharge delay is reduced to less than the width of the scan pulse, allowing a discharge to be generated. The voltage difference between the electrodes A and Y is increased as the magnitudes of Vₐ and V_{scL} are increased, because Vₐ is positive and V_{scL} is negative and an increase in their magnitudes means a greater voltage difference between them. Similarly, generation of the address discharge may be facilitated by setting the voltage V_{scL} to be lower than the voltage V_{nf}.

Subsequently, during the sustain period, a sustain discharge is generated between the Y and X electrodes by initially applying a pulse, in the form of the voltage Vₛ, to the Y electrode. Just before the application of this voltage, the wall voltage V_{wxy} is formed such that the potential of the Y electrode is higher than the X electrode in the discharge cells 12 having undergone the address discharge during the address period. During the sustain period, the voltage Vₛ is set to be lower than a discharge firing voltage V_{fxy}, between the X and Y electrodes, while the sum of the voltages Vₛ+V_{wxy} is set to be higher than the voltage V_{fxy}. In this manner, the positive wall voltage V_{wxy}, from the Y electrode to the X electrode, existing before the application of Vₛ does not generate a discharge. At the same time, once Vₛ arrives, the sum of these two generally positive voltages Vs+V_{wxy} will reach above the required firing voltage V_{fxy} discharge between X and Y electrodes and a discharge is sustained.

As a result of the sustain discharge, negative (−) wall charges are formed on the Y electrode and positive (+) wall charges are formed on the X and A electrodes, such that the potential of the X electrode wall is higher than the Y electrode wall. Because the voltage V_{wyx} is formed such that the potential of the Y electrode itself, and not its adjacent wall, becomes higher than the X electrode itself, a pulse of a negative voltage −Vₛ is applied to the Y electrode to fire a subsequent sustain discharge. As a result of this discharge, once again positive (+) wall charges are formed on the Y electrode and negative (−) wall charges are formed on the X and A electrodes such that another sustain discharge may be generated by applying the positive voltage Vₛ to the Y electrode.

The process of alternately applying the sustain pulses of Vₛ and −Vₛ to the Y electrode is repeated a number of times corresponding to a weight value of a corresponding subfield.

As described above, according to the first embodiment of the present invention shown in FIG. 4, reset, address, and sustain operations may be performed by a driving waveform applied only to the Y electrode while the X electrode is biased at the reference voltage. Accordingly, a driving board for driving the X electrode is not required and the X electrode may stay simply biased at a reference voltage, for example, at 0V. Because the sustain pulses are only supplied from the scan driving board 200, the impedance formed by the voltage Vₛ applied to the Y electrode is substantially the same as the impedance formed by the voltage −Vₛ applied to the Y electrode.

The voltage of the Y electrode is changed from the voltage Vₛ to the voltage −Vₛ or from the voltage −Vₛ to the voltage Vₛ during the sustain period of the first exemplary embodiment. During this period, a self-erasing discharge may be generated in the discharge cell 12 by the variation of 2Vₛ in the voltage. Then, the wall charges formed on the X and Y electrodes by the sustain discharge may be eliminated by the self-erasing discharge before the next voltage Vₛ or −Vₛ is applied to the Y electrode. If the self-erasing discharge is generated in the discharge cell 12, the subsequent sustain discharge may not be generated or may be weakly generated in the discharge cell 12. As a result, the desired gray scale may not be represented in the discharge cell 12.

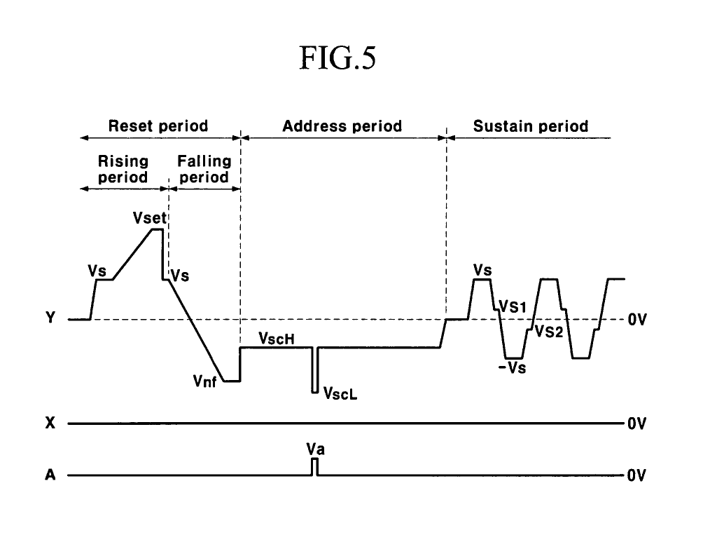

A second exemplary embodiment for preventing the self-erasing discharge is described with reference to FIG. 5.

As shown in FIG. 5, the driving waveform of the plasma display according to the second exemplary embodiment is similar to the first exemplary embodiment. However, the voltage of the Y electrode is decreased from the voltage Vₛ to a voltage Vₛ₁ and subsequently further decreased to the voltage −Vₛ before being increased from the voltage −Vₛ to the voltage Vₛ₂ and back to the voltage Vₛ during the sustain period. The voltage Vₛ₁ is higher than the voltage −Vₛ and is lower than the voltage Vₛ. The voltage Vₛ₂ is higher than the voltage −Vₛ and is lower than the voltage Vₛ. The Y electrode may be maintained at the voltage Vₛ₂ during a predetermined period after being increased from the voltage −Vₛ to the voltage Vₛ₂, and/or the Y electrode may be maintained at the voltage Vₛ₁ during a predetermined period after being reduced from the voltage Vₛ to the voltage Vₛ₁.

As a result, the self-erasing discharge can be prevented because variation in the voltage of the Y electrode is less than the voltage 2Vₛ.

The voltage Vₛ₁ may be set to be higher than the reference voltage 0V. Then, because the difference between the voltage Vₛ₁ and the voltage −Vₛ is higher than the difference between the voltage Vₛ and the voltage Vₛ₁, the sustain discharge may be stably generated when the voltage −Vₛ is applied to the Y electrode during the sustain period.

Further, the voltage Vₛ₂ may be set to be lower than the reference voltage 0V. Then, because the difference between the voltage Vₛ and the voltage Vₛ₂ is higher than the difference between the voltage Vₛ₂ and the voltage −Vₛ, the sustain discharge may be stably generated when the voltage Vₛ is applied to the Y electrode during the sustain period.

While the constant reference voltage 0V is applied to the X electrode during the reset, address and sustain periods of the subfield in the second exemplary embodiment, the X electrode may be biased at a voltage which is higher than the reference voltage 0V during the falling period of the reset period and/or during the address period. Then, the voltage applied to the Y electrode may be higher than the voltage V_{nf} or V_{scL} shown in FIG. 4 or FIG. 5 because the voltage of the X electrode is higher than the reference voltage 0V.

Because a voltage different from the reference voltage 0V may also be applied from the scan driving board 200, an extra board for driving the X electrode can be eliminated. In addition, the impedance along the path for applying the sustain pulse of the voltage Vₛ may be substantially the same as the impedance along the path for applying the sustain pulse of the voltage −Vₛ because the sustain pulse is supplied from the scan driving board.

While, in the first and second exemplary embodiments, the voltage of the Y electrode has been described as gradually changing in a ramp fashion, the voltage of the Y electrode may be gradually changed in other forms as well.

In addition, while in the first and second exemplary embodiments, the reset period has been described as including both the rising period and the falling period, the reset period may include only the falling period in some subfields of the frame.

According to the exemplary embodiments of the present invention, an extra board for driving the X electrode may be eliminated because the X electrode is biased at a constant voltage. As a result, the cost for manufacturing the plasma display may be reduced.

While this invention has been described in connection with what is presently considered to be practical exemplary embodiments, it is to be understood that the invention is not limited to the disclosed embodiments, rather, is intended to cover various modifications and equivalent arrangements included within the spirit and scope of the appended claims, and their equivalents.

What is claimed is:

1. A driving method of a plasma display for displaying an image during a frame, the frame being divided into a plurality of subfields, the plasma display including first electrodes, second electrodes, and third electrodes, the third electrodes extending substantially perpendicular to the first electrodes and the second electrodes, the driving method comprising during a sustain period of each subfield:
applying a first voltage to the first electrodes,
applying a second voltage which is higher than the first voltage to the second electrodes;
reducing a voltage of the second electrodes from the second voltage to a third voltage;
reducing the voltage of the second electrodes from the third voltage to a fourth voltage which is lower than the first voltage;
increasing the voltage of the second electrodes from the fourth voltage to a fifth voltage which is lower than the second voltage; and
increasing the voltage of the second electrodes from the fifth voltage to the second voltage,
wherein at least one of the third voltage and the fifth voltage is different from a sixth voltage which is an average of the second voltage and the fourth voltage.

2. The driving method of claim 1, wherein the third voltage is higher than the sixth voltage.

3. The driving method of claim 1, wherein the fifth voltage is lower than the sixth voltage.

4. The driving method of claim 1, wherein the sixth voltage is equal to the first voltage.

5. The driving method of claim 4, wherein the first voltage is a ground voltage.

6. The driving method of claim 1, further comprising applying a seventh voltage to the first electrodes during a portion of a reset period and an address period of the subfield.

7. The driving method of claim 6, wherein the seventh voltage is equal to the first voltage.

8. The driving method of claim 6, wherein the seventh voltage is higher than the first voltage.

9. The driving method of claim 6, wherein applying the seventh voltage to the first electrodes during the portion of the reset period comprises reducing the voltage of the second electrodes from an eighth voltage to ninth voltage.

10. The driving method of claim 6, further comprising sequentially applying a scan pulse to the second electrodes and selectively applying an address pulse to the third electrodes while applying the first voltage to the first electrodes during the address period.

11. The driving method of claim 6, wherein the first voltage is a ground voltage.

12. The driving method of claim 1, wherein the second electrodes are maintained at either the third voltage or the first voltage during a predetermined period after the voltage of the second electrodes is changed to the either the third voltage or the fifth voltage respectively.

13. A plasma display comprising:
a plasma display panel including a plurality of first electrodes, a plurality of second electrodes and a plurality of third electrodes, the third electrodes extending substantially perpendicular to the first electrodes and the second electrodes;
a controller for dividing a frame into a plurality of subfields; and
a driver for applying a first voltage to the first electrodes and for applying a second voltage which is higher than the first voltage and a third voltage which is lower than the first voltage in turn to the second electrodes during a sustain period of each subfield,
wherein during either a first period during which the voltage of the second electrodes is reduced from the second voltage to the third voltage, or a second period during which the voltage of the second electrodes is increased from the third voltage to the second voltage, or both the first period and the second period, the driver applies a fourth voltage different from the first voltage to the second electrodes during a third period shorter than the first period and the second period.

14. The plasma display of claim 13, wherein the driver applies the fourth voltage to the second electrodes during the third period coinciding with the first period, and the fourth voltage is higher than the first voltage.

15. The plasma display of claim 13, wherein the driver applies the fourth voltage to the second electrodes during the third period coinciding with the second period, and the fourth voltage is lower than the first voltage.

16. The plasma display of claim 13, wherein the driver applies a driving waveform, for displaying an image on the plasma display panel, to the second electrodes and to the third electrodes while applying the first voltage to the first electrodes during the plurality of subfields.

17. The plasma display of claim 16, wherein the first voltage is a ground voltage.

18. The plasma display of claim 13,
wherein each of the subfields is divided into a reset period, an address period, and a sustain period,
wherein discharge cells are formed at intersections of the first electrodes and the second electrodes with the third electrodes, and
wherein upon receiving an external image signal, the controller generates an address driving control signal for driving the third electrodes and a scan driving control signal for driving the first electrodes and the second electrodes.

19. The plasma display of claim 18, wherein the driver further includes:
an address buffer board coupled to the controller, the address buffer board for receiving the address driving control signal from the controller and for applying a voltage for selecting a turn-on discharge cell from among the discharge cell to addressed third electrodes;
a scan driving board coupled to the second electrodes, the scan driving board for receiving the scan driving control signal from the controller and for applying a driving voltage to the second electrodes; and
a scan buffer board coupling the scan driving board to the second electrodes, the scan buffer board for applying a voltage to the second electrodes for sequentially selecting the second electrodes during the address period.

20. The plasma display of claim 19, wherein the scan buffer board and the scan driving board comprise a single integral part.
